(19) United States
(12) Patent Application Publication
(10) Pub. No.: US 2025/0220645 A1
(43) Pub. Date: Jul. 3, 2025

(54) Wireless audio data transmission method and related device

(71) Applicant: NANJING ZGMICRO COMPANY LIMITED, Nanjing (CN)

(72) Inventor: Bin XU, Nanjing (CN)

(21) Appl. No.: 19/004,401

(22) Filed: Dec. 29, 2024

(30) Foreign Application Priority Data
Dec. 29, 2023 (CN) 202311869519.9

(51) Int. Cl. H04W 72/0446; H04L 5/00; H04R 3/00; H04W 84/20

(52) U.S. Cl. CPC H04W 72/0446; H04L 5/0053; H04R 3/00; H04R 2420/07; H04W 84/20

(57) ABSTRACT

Wireless audio data transmission method and related device are described. The method is applied to a master device. The master device transmits a first audio packet to a slave device within consecutive first isochronous intervals based on a first communication link, and/or receives a second audio packet transmitted by the slave device within consecutive second isochronous intervals based on a second communication link. A time length of the first isochronous interval is less than that of the second isochronous interval. The first isochronous interval comprises a first time slot for transmitting the first audio packet and a second time slot being a time slot other than the first time slot within each first isochronous interval. The second isochronous interval comprises a third time slot for transmitting the second audio packet. A time domain position of the third time slot within one of the second isochronous intervals at least partially overlaps with a time domain position of one second time slot in the consecutive first isochronous intervals.

### CROSS-REFERENCE OF RELATED APPLICATIONS

The present invention claims priorities of Chinese Patent Application No. 2023118695199 filed in China on Dec. 29, 2023, the entire contents of which are incorporated herein by reference.

### BACKGROUND OF THE INVENTION

### Field of the Invention

The present invention relates to the technical field of wireless audio, and specifically relates to a wireless audio data transmission method and related device.

### Description of the Related Art

In Bluetooth Low Energy (BLE) audio applications, Isochronous Channels protocols, that is, a Connected Isochronous Stream (CIS) link for point-to-point communication and a Connected Isochronous Group (CIG) protocol composed of multiple CIS links, as well as a Broadcast Isochronous Stream (BIS) link for point-to-multipoint communication and a Broadcast Isochronous Group (BIG) protocol composed of multiple BIS links, are adopted in the related art to provide wireless audio services to users. For example, a wireless gaming headset or wireless gaming audio system composed of a wireless microphone and a wireless headphone is implemented by using the CIG link composed of one or two bidirectional CIS links.

When implementing the wireless gaming audio system based on the CIG link, it is found that in the bidirectional wireless gaming audio system, a time delay requirement in a headphone direction is higher than that in a microphone direction. However, when the CIG link performs a bidirectional communication, it is required that the time delays in the two communication directions remain the same. Therefore, if the relevant parameters of the CIG link are configured based on the time delay requirement in the headphone direction, it will lead to excessive implementation difficulty of the wireless gaming audio system and problems such as audio data loss. If the relevant parameters of the CIG link are configured based on the time delay requirement in the microphone direction, the time delay requirement in the headphone direction of the wireless gaming audio system cannot be met.

In other words, the related technologies cannot meet the different time delay requirements of the wireless gaming audio system in different communication directions.

### SUMMARY OF THE INVENTION

The purpose of the present invention is to provide a wireless audio data transmission method and a wireless audio data transmission device, which is used to solve the technical problem that the related technologies cannot meet the different time delay requirements of the wireless gaming audio system in different communication directions.

To achieve the purpose, according to one aspect of the present invention, a wireless audio data transmission method applied to a master device is provided. The wireless audio data transmission method comprises: transmitting a first audio packet to a slave device in consecutive first isochronous intervals based on a first communication link by the master device; and/or, receiving a second audio packet transmitted from the slave device in consecutive second isochronous intervals based on a second communication link by the master device. A time length of each first isochronous interval is less than a time length of each second isochronous interval, each first isochronous interval comprises a first time slot for the master device to transmit the first audio packet and a second time slot being a time slot other than the first time slot within each first isochronous interval, and each second isochronous interval comprises at least one third time slot for the slave device to transmit the second audio packet. A time domain position of the third time slot within one of the second isochronous intervals at least partially overlaps with a time domain position of one second time slot in the consecutive first isochronous intervals.

According to another aspect of the present invention, a wireless audio data transmission method applied to a slave device is provided. The wireless audio data transmission method comprises: receiving a first audio packet transmitted by the master device in consecutive first isochronous intervals based on a first communication link by the slave device; or receiving the first audio packet transmitted by the master device based on the first communication link in successive first isochronous intervals, and transmitting a second audio packet to the master device based on a second communication link in consecutive second isochronous intervals by the slave device. A time length of each first isochronous interval is less than a time length of each second isochronous interval, each first isochronous interval comprises a first time slot for the master device to transmit the first audio packet and a second time slot being a time slot other than the first time slot within each first isochronous interval, and each second isochronous interval comprises at least one third time slot for the slave device to transmit the second audio packet. A time domain position of the third time slot within one of the second isochronous intervals at least partially overlaps with a time domain position of one second time slot in the consecutive first isochronous intervals.

According to another aspect of the present invention, a wireless audio data transmission device applied to a master device is provided. The wireless audio data transmission comprises: a first transmission module for transmitting a first audio packet to a slave device in consecutive first isochronous intervals based on a first communication link by the master device, and/or, receiving a second audio packet transmitted from the slave device in consecutive second isochronous intervals based on a second communication link. A time length of each first isochronous interval is less than a time length of each second isochronous interval, each first isochronous interval comprises a first time slot for the master device to transmit the first audio packet and a second time slot being a time slot other than the first time slot within each first isochronous interval, and each second isochronous interval comprises at least one third time slot for the slave device to transmit the second audio packet. A time domain position of the third time slot within one of the second isochronous intervals at least partially overlaps with a time domain position of one second time slot in the consecutive first isochronous intervals.

In the present invention, a wireless audio data transmission device applied to a slave device is provided. The wireless audio data transmission comprises: a second transmission module for receiving a first audio packet transmitted by the master device in consecutive first isochronous intervals based on a first communication link by the slave device; or receiving the first audio packet transmitted by the master device based on the first communication link in successive first isochronous intervals, and transmitting a second audio packet to the master device based on a second communication link in consecutive second isochronous intervals by the slave device. A time length of each first isochronous interval is less than a time length of each second isochronous interval, each first isochronous interval comprises a first time slot for the master device to transmit the first audio packet and a second time slot being a time slot other than the first time slot within each first isochronous interval, and each second isochronous interval comprises at least one third time slot for the slave device to transmit the second audio packet. A time domain position of the third time slot within one of the second isochronous intervals at least partially overlaps with a time domain position of one second time slot in the consecutive first isochronous intervals.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic flowchart of a wireless audio data transmission method provided according to one embodiment of the present invention;

FIG. 2 is a schematic flowchart for establishing a second communication link by an ABIS (Asymmetric Bidirectional Isochronous Stream) master device provided according to one embodiment of the present invention;

FIG. 3 is a schematic flowchart for establishing the second communication link by a ABIS slave device provided according to one embodiment of the present invention;

FIG. 4 is a schematic diagram of a timing relationship of the second communication link provided according to one embodiment of the present invention;

FIG. 5 is a schematic diagram of a common extended advertising payload format provided according to one embodiment of the present invention;

FIG. 6 is a schematic diagram of an extended header format provided according to one embodiment of the present invention;

FIG. 7 is a schematic diagram of an extended header flag bit provided according to one embodiment of the present invention;

FIG. 8 is a schematic diagram of a header of an ABISS PDU provided according to one embodiment of the present invention;

FIG. 9 is a schematic flowchart of another wireless audio data transmission method provided according to one embodiment of the present invention;

FIG. 10 is a schematic diagram of a header of an ABISM PDU provided according to one embodiment of the present invention;

FIG. 11 is a schematic diagram of a ULLWGA system provided according to one embodiment of the present invention;

FIG. 12(a) is a schematic diagram of a time slot structure of an ABIS link provided according to one embodiment of the present invention;

FIG. 12(b) is a schematic diagram of another time slot structure of the ABIS link provided according to one embodiment of the present invention;

FIG. 12(c) is a schematic diagram of yet another time slot structure of the ABIS link provided according to one embodiment of the present invention;

FIG. 13 is a schematic diagram of a transmission and reception process of the ABIS master device according to one embodiment of the present invention;

FIG. 14 is a schematic diagram of a transmission and reception process of the ABIS slave device according to one embodiment of the present invention;

FIG. 15 is a schematic diagram of a wireless audio data transmission device provided according to one embodiment of the present invention;

FIG. 16 is a schematic diagram of another wireless audio data transmission device provided according to one embodiment of the present invention;

FIG. 17 is a schematic diagram of a wireless audio data transmission system provided according to one embodiment of the present invention;

FIG. 18 is a schematic diagram of the structure of a ULLWGA device provided according to one embodiment of the present invention; and

FIG. 19 is a schematic structural diagram of an electronic device provided according to one embodiment of the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

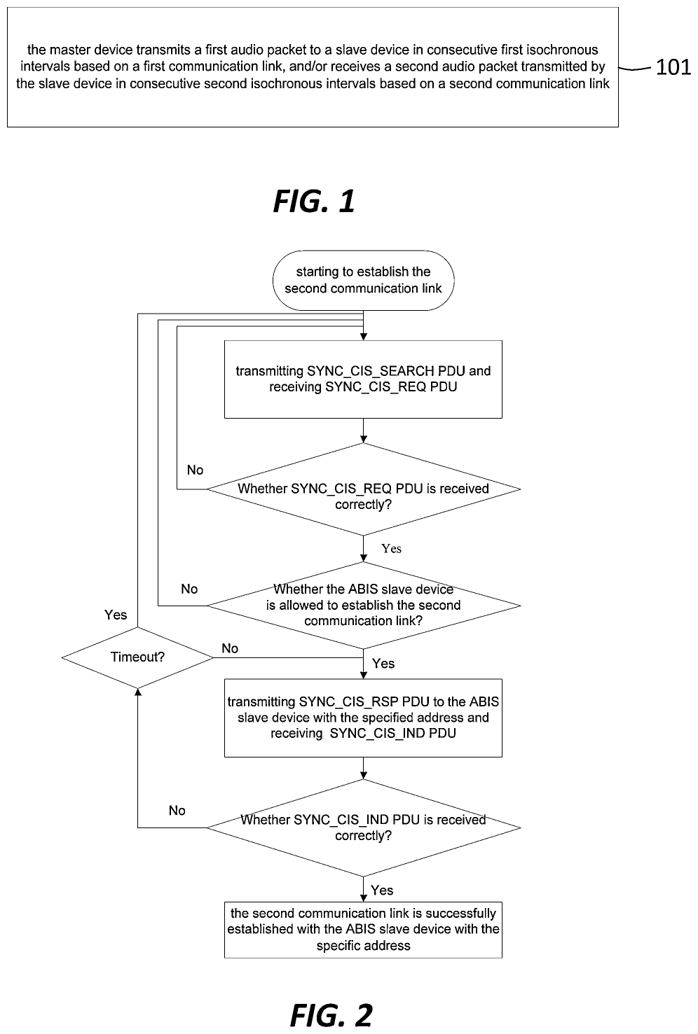

As shown in FIG. 1, a wireless audio data transmission method applied to a master device is provided according to one embodiment of the present invention provides. The method comprises: the master device transmits a first audio packet to a slave device in consecutive first isochronous intervals based on a first communication link, and/or receives a second audio packet transmitted by the slave device in consecutive second isochronous intervals based on a second communication link at 101.

A time length of the first isochronous interval is less than the time length of the second isochronous interval. The first isochronous interval comprises a first time slot and a second time slot. The second isochronous interval comprises a third time slot. The first time slot is a time slot for the master device to transmit the first audio packet. The second time slot is a time slot other than the first time slot within the first isochronous interval. The third time slot is a time slot for the slave device to transmit the second audio packet. A time domain position of the third time slot in one of the second isochronous intervals at least partially overlaps with the time domain position of one second time slot in the consecutive first isochronous intervals.

For example, the master device may be a smart phone, a personal computer, a tablet computer, a smart TV, a wireless game console, etc., and the slave device may be a wireless gaming headset, etc.

It should be noted that the number of slave devices receiving the first audio packet from the master device may be multiple. However, among the multiple slave devices, if the slave device A transmits the second audio packet to the master device in consecutive second isochronous intervals based on the second communication link, then other slave devices except the slave device A among the multiple slave devices are prohibited from transmitting the second audio packet to the master device. That is, in the transmission direction of the master device, the multiple slave devices may receive the audio data broadcast by the master device. However, in the transmission direction of the slave device, at each time period, the master device only allows one of the multiple slave devices to transmit the audio data to the master device.

The slave device may perform one or more transmitting actions of the second audio packet at the third time slot. This transmitting action may be an action of transmitting a new second audio packet for the first time or an action of retransmitting the original second audio packet.

In order to reasonably allocate time slot resources between two asymmetric communication links, the time domain position of the third time slot at least partially overlaps with the time domain position of the second time slot within the consecutive first isochronous intervals. The master device alternately transmits the first audio packet based on the first communication link in the first isochronous interval and receives the second audio packet based on the second communication link in the second isochronous interval, so that the communication efficiency may be improved.

In one embodiment, the time domain position of one third time slot may completely overlap with the time domain position of one second time slot.

In another embodiment, the time domain position of one third time slot may also partially overlap with the time domain position of one second time slot. For example, a starting time point of one third time slot is aligned with a starting time point of the second time slot, but an ending time point of the one third time slot is before an ending time point of the second time slot.

In one alternative embodiment, the ending time point of one third time slot is aligned with the ending time point of the second time slot, but the starting time point of the one third time slot is after the starting time point of the second time slot.

In one alternative embodiment, the time domain interval of one third time slot is inside the time domain interval of the second time slot, that is, the ending time point of the one third time slot is after the starting time point of the second time slot, and the starting time point of this third time slot is before the ending time point of the second time slot.

In one alternative embodiment, part of the time domain interval of one third time slot is within the time domain interval of the second time slot, and part of the time domain interval of the one third time slot extends into the time domain interval of the first time slot.

It can be understood that it is not required that for each second time slot, there is a corresponding third time slot that overlaps with it in the time domain.

In one embodiment, the time length of the second isochronous interval is i times the time length of the first isochronous interval, wherein i is an integer greater than 1.

In one embodiment, in order to balance coding performance of bidirectional communication, an encoded frame length of the first communication link is less than an encoded frame length of the second communication link.

In one embodiment, the first time slot comprises Q1 first sub-event intervals, the second time slot comprises Q2 first sub-event intervals, and the second isochronous interval comprises P second sub-event intervals. Q1, Q2, and P are all positive integers.

It can be understood that, usually, one sub-event interval is used for one type of communication event, such as transmitting/receiving the audio packets, performing bidirectional/unidirectional periodic advertising communication, performing bidirectional/unidirectional control information interaction/transmitting, and so on.

It can be understood that, in specific implementation, the time length of the first time slot and the time length of the second time slot may be the same or different. The time length of the first sub-event interval contained in the first time slot may be the same as or different from the time length of the first sub-event interval contained in the second time slot. Even the time length of the sub-event intervals in the same isochronous interval may be the same or different. For example, when different types of communication events are performed in different sub-event intervals, the time length of the sub-event intervals may be different. Specific settings may be made according to actual application scenarios, and the present invention does not limit this.

In one embodiment, the time length of each sub-event interval in the same isochronous interval may be set to be the same.

In one embodiment, the time length of the second sub-event interval may also be set to be an integer multiple of the time length of the first isochronous interval.

In one embodiment, in order to further reasonably arrange time slots so that the two asymmetric links transmit the audio data in a time-sharing manner, the starting time point of the earliest first sub-event interval among the Q2 first sub-event intervals of the second time slot is a first starting point of the second time slot.

The starting time point of the third time slot in one second sub-event interval is the same as the first starting point of one second time slot, such that the time domain position of the third time slot at least partially overlaps with the time domain position of one second time slot in the consecutive first isochronous intervals.

In one embodiment, the communication direction of the master device may be set to adopt a communication mode without immediate acknowledgement or a communication mode in which retransmission does not depend on the acknowledgement, so as to avoid time delay caused by the manner of replying with acknowledgement or retransmitting depending on the acknowledgement, so that the time delay in the communication direction of the master device is further reduced.

In one embodiment, the time domain positions of the Q1 first sub-event intervals are sequentially adjacent within the first isochronous interval. The master device continuously transmits the first audio packet NSE_M times within the Q1 first sub-event intervals. NSE_M is less than or equal to Q1.

In this embodiment, through the time domain positions of the Q1 first sub-event intervals being sequentially adjacent within the first isochronous interval, multiple transmitting opportunities are provided for the first audio packet in a continuous period. Therefore, the audio data transmission method which does not need immediate acknowledgement and does not rely on acknowledgement for retransmission may reduce the time delay while ensuring the transmission reliability.

In one embodiment, the master device transmits link information of the first communication link based on the periodic advertising channel within the second time slot for the slave device to synchronize with the master device and to receive the first audio data packet based on the first communication link.

The master device also performs bidirectional communication with the slave device based on the periodic advertising channel within the second time slot to negotiate and establish the second communication link.

In related technologies, the establishment and maintenance of the communication link in the direction of the slave device rely on an additional BLE ACL link. However, the BLE ACL link will occupy limited time slot resources, and the BLE ACL link cannot share time slot resources with the CIG link. In the present invention, the master device avoids additional time slot resource occupation when the second communication link is established by multiplexing the periodic advertising channel and adopting bidirectional communication. Therefore, it may further improve the communication efficiency of bidirectional communication and reduce the communication delay.

In the present invention, the first communication link and the second communication link may be collectively referred to as an Asymmetric Bidirectional Isochronous Stream (ABIS) link. The master device may also be referred to as an ABIS master device, and the slave device as an ABIS slave device.

For example, in the present invention, the first communication link is a point-to-multipoint communication link, similar to the BLE BIS link. It only requires to be established unidirectionally by the ABIS master device. That is, the ABIS master device transmits an ADV_EXT_IND Protocol Data Unit (PDU) on a primary advertising channel, transmits an AUX_ADV_IND PDU on a secondary advertising channel, and transmits a SYNC_CIS_SEARCH PDU on the periodic advertising channel to facilitate the ABIS slave device to synchronize and obtain the link information ABIS Info of the first communication link, so that the ABIS slave device may synchronize with the ABIS master device and receive the first audio packet transmitted by the ABIS master device within the first isochronous interval. As a typical embodiment, the link information ABIS Info of the first communication link may be set with reference to the BLE BIG Info.

The second communication link needs to be jointly negotiated and established by the ABIS master device and the ABIS slave device.

The second time slot comprises a Bidirectional Periodic Advertising (BPA) time slot. In one typical embodiment, the bidirectional periodic advertising time slot may be one of the first sub-event intervals, that is, the bidirectional periodic advertising communication is performed once within one of the first sub-event intervals.

The master device periodically transmits a synchronization search packet SYNC_CIS_SEARCH PDU based on the periodic advertising channel in the bidirectional periodic advertising time slot based on a predetermined bidirectional periodic advertising interval (BPA interval), and receives a connection request packet SYNC_CIS_REQ PDU fed back by a candidate slave device. It can be understood that the time length of the bidirectional periodic advertising interval may be set according to related periodic advertising technologies, such as periodic advertising in the Bluetooth low energy technology. For example, it is usually an integer multiple of the time length of the first isochronous interval.

The master device transmits a request search command based on the synchronization search packet and obtains the link connection request fed back by the candidate slave device based on the received connection request packet. It can be understood that during the process of the master device periodically broadcasting the synchronization search packet, the master device may receive the connection request packets transmitted by the multiple candidate slave devices.

The master device determines one of the candidate slave devices as a target slave device based on the link connection request, and the target slave device is allowed to establish the second communication link with the master device.

The master device transmits a connection response packet SYNC_CIS_RSP PDU to the target slave device and receives a connection indication packet AUX_SYNC_IND PDU fed back by the target slave device.

The master device establishes the second communication link with the target slave device based on the connection indication packet.

As a specific embodiment, the synchronization search packet may comprise: a device address of the master device and the link information ABIS Info of the first communication link. Based on the synchronization search packet, any slave device can synchronize with the master device and receive the first audio packet transmitted by the ABIS master device based on the first communication link within the first isochronous interval.

The connection request packet may comprise: a parameter indicating a device address of the candidate slave device, a parameter indicating the device address of the master device, a link connection request indicating that the candidate slave device establishes the second communication link with the master device, and a first payload data corresponding to the link connection request.

The connection response packet may comprise: a parameter indicating the device address of the target slave device, a parameter indicating the device address of the master device, a request response indicating the master device's link connection request to the target slave device, and a second payload data corresponding to the request response.

The connection indication packet may comprise: a parameter indicating the device address of the target slave device, a parameter indicating the device address of the master device, a link connection indication indicating that the target slave device establishes the second communication link with the master device, and a third payload data corresponding to the link connection indication.

As shown in FIG. 2, a process for the ABIS master device to establish the second communication link is as follows.

After the ABIS master device starts to establish the second communication link, it first transmits the SYNC_CIS_SEARCH PDU and receives the SYNC_CIS_REQ PDU. If the SYNC_CIS_REQ PDU is not correctly received, it continues to transmit the SYNC_CIS_SEARCH PDU and receive the SYNC_CIS_REQ PDU.

If the SYNC_CIS_REQ PDU is correctly received and the ABIS slave device with corresponding device address is allowed to establish the second communication link, the ABIS master device transmits the SYNC_CIS_RSP PDU to the ABIS slave device with the specified address and receives the SYNC_CIS_IND PDU. Otherwise, the ABIS master device continues to transmit the SYNC_CIS_SEARCH PDU to search for the ABIS slave device.

If the SYNC_CIS_IND PDU is correctly received, the second communication link is successfully established with the ABIS slave device with the specific address. Otherwise, the ABIS master device continues to transmit the SYNC_CIS_RSP PDU until the SYNC_CIS_IND PDU is correctly received, or the ABIS master device retransmits the SYNC_CIS_SEARCH PDU and receives the SYNC_CIS_REQ PDU after a timeout.

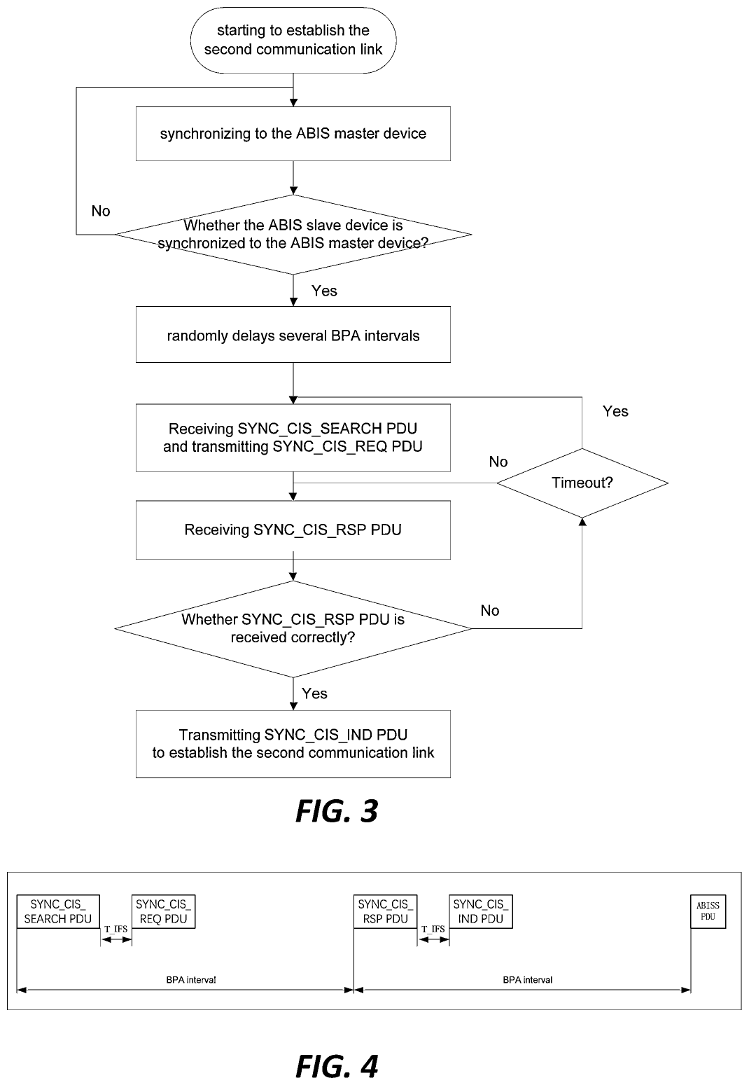

As shown in FIG. 3, a process for the ABIS slave device to establish the second communication link is as follows.

After the ABIS slave device starts to establish the second communication link, the ABIS slave device first synchronizes to the ABIS master device. That is, the ABIS slave device first searches for the ADV_EXT_IND PDU transmitted by the ABIS master device on the primary advertising channel, then receives the AUX_ADV_IND PDU transmitted by the ABIS master device on the secondary advertising channel, and then receives the SYNC_CIS_SEARCH PDU transmitted by the ABIS master device on the periodic advertising channel, so as to synchronize with the ABIS master device.

After synchronizing with the ABIS master device, the ABIS slave device randomly delays several bidirectional periodic advertising intervals. After receiving the SYNC_CIS_SEARCH PDU again, the ABIS slave device transmits the SYNC_CIS_REQ PDU after an interval of T_IFS. For reliability, the ABIS slave device may also receive the SYNC_CIS_SEARCH PDU and transmit the SYNC_CIS_REQ PDU over multiple BPA intervals.

Then, the ABIS slave device receives the SYNC_CIS_RSP PDU transmitted by the ABIS master device. If the SYNC_CIS_RSP PDU is correctly received, after an interval of T_IFS, the ABIS slave device reply with the SYNC_CIS_IND PDU to establish the second communication link. Otherwise, the ABIS slave device continuously receives the SYNC_CIS_RSP PDU until a timeout occurs. After the timeout, the ABIS slave device receives the SYNC_CIS_SEARCH PDU again and transmit the SYNC_CIS_REQ PDU. The above process is repeated until the second communication link is established.

The BPA interval is equal to the interval at which the ABIS master device transmits the SYNC_CIS_SEARCH PDU on the periodic advertising channel. Randomly delaying several BPA intervals may avoid multiple ABIS slave devices from simultaneously transmitting SYNC_CIS_REQ PDUs and interfering with each other.

In one embodiment, a timing relationship of the ABIS master device and the ABIS slave device establishing the second communication link through BPA is shown in FIG. 4. In FIG. 4, the ABISS PDU may be understood as the second audio packet. The ABIS master device transmits the SYNC_CIS_SEARCH PDU on the periodic advertising channel. After the ABIS slave device that wants to establish the second communication link synchronizes with the ABIS master device and receive the SYNC_CIS_SEARCH PDU, it may reply with the SYNC_CIS_REQ PDU on the periodic advertising channel after the interval of T_IFS to request establishment of the second communication link. T_IFS is a Time of Inter Frame Space. After the ABIS master device receives the SYNC_CIS_REQ PDU transmitted by the slave device, the ABIS master device confirms that the slave device is allowed to establish the second communication link according to its device address, device name or Universally Unique Identifier (UUID), and then transmits the SYNC_CIS_RSP PDU on the periodic advertising channel to the ABIS slave device with corresponding device address. After the ABIS slave device receives the SYNC_CIS_RSP PDU transmitted by the ABIS master device, the ABIS slave device immediately transmits the SYNC_CIS_IND PDU on the periodic advertising channel after an interval of T_IFS to establish the second communication link.

T_IFS may be set to 150 us according to the BLE protocol.

In addition, if the ABIS master device does not receive the SYNC_CIS_IND PDU transmitted by the ABIS slave device, it needs to retransmit the SYNC_CIS_RSP PDU until the ABIS master device correctly receives the SYNC_CIS_IND PDU transmitted by the ABIS slave device or stops transmitting due to the timeout. In this embodiment, only the ABIS slave device with the specified address in the SYNC_CIS_RSP PDU may transmit the SYNC_CIS_IND PDU after the interval of T_IFS.

It should be noted that in FIG. 4, for the convenience of illustration, the ABIS master device transmits the SYNC_CIS_RSP PDU in the next BPA interval after receiving the SYNC_CIS_REQ PDU. In actual applications, the SYNC_CIS_RSP PDU may be transmitted after waiting for several BPA intervals. Here, the setting of the ABIS master device waiting for several BPA intervals may support the ABIS master device to select a target slave device that is suitable for actual needs (such as the slave device with the best network environment or the slave device with a specific model) when multiple ABIS slave devices request to establish the second communication link with the ABIS master device. This may make the selection of the ABIS slave devices allowed to establish the second communication link more flexible.

Further, a synchronization connection process of the ABIS slave device and the ABIS master device is as follows.

The ABIS slave device first searches for an extended advertising (ADV_EXT_IND PDU) transmitted by the ABIS master device on the primary advertising channel, then receives an auxiliary advertising (AUX_ADV_IND PDU) transmitted by the ABIS master device on the secondary advertising channel, and then receives a synchronization connection isochronous stream search (SYNC_CIS_SEARCH) PDU transmitted by the ABIS master device on the periodic advertising channel to synchronize with the ABIS master device and obtain the link information ABIS Info of the first communication link, so as to receive the audio data carried by the ABISM PDU.

As mentioned above, after the ABIS slave device synchronizes with the ABIS master device, if the ABIS slave device needs to transmit the audio data, the ABIS slave device may request to establish the second communication link by transmitting a synchronization connection isochronous stream request (SYNC_CIS_REQ) PDU to the ABIS master device.

After the ABIS master device receives the SYNC_CIS_REQ PDU, it may select one ABIS slave device with a specific address and confirm the establishment of the second communication link by transmitting the synchronization connection isochronous stream response (SYNC_CIS_RSP) PDU.

After the ABIS slave device receives the SYNC_CIS_RSP PDU, the ABIS slave device immediately transmits a synchronization connection isochronous stream indication (SYNC_CIS_IND) PDU to establish the second communication link. For ease of understanding, in this article, the link between the ABIS master device and the ABIS slave device for interacting with the above PDUs may be called is referred to as a Bidirectional Periodic Advertising (BPA) link.

In a specific embodiment, the first communication link may be set with reference to the BLE BIS link, and the second communication link may be set with reference to the BLE CIS link.

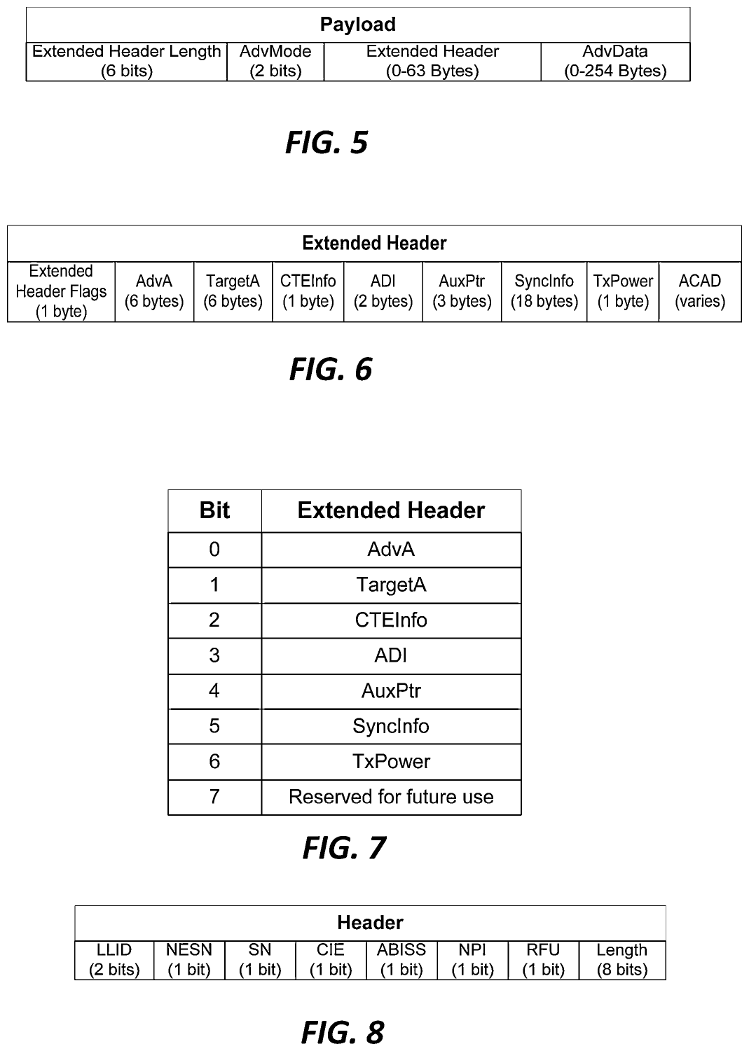

The SYNC_CIS_SEARCH PDU, SYNC_CIS_REQ PDU, SYNC_CIS_RSP PDU, and SYNC_CIS_IND PDU are similar to the AUX_SYNC_IND PDU of the BLE Audio protocol. They all adopt a common extended advertising payload format shown in FIG. 5 in the BLE Audio specification. The common extended advertising payload format comprises an extended header length of 6 bits, an advertising mode (AdvMode) of 2 bits, an extended header of 0-63 bytes, and an advertising data (AdvData) of up to 254 bytes.

As shown in FIG. 6, the extended header format may comprise fields such as Extended Header Flags, AdvA, TargetA, CTEInfo, ADI, AuxPtr, SyncInfo, TxPower, and ACAD.

The Extended Header Flags is extended header flag bits. As shown in FIG. 7, each bit of the extended header flag bits corresponds to a field of the extended header. Setting a certain bit to 1 means that the extended header contains corresponding field. Setting a certain bit to 0 means that the extended header does not contain corresponding field.

The AdvA field represents the device address of the advertising transmitting device. The TargetA field represents the device address of the target device. The CTEInfo field represents Constant Tone Extension (CTE) information. The ADI field represents advertising data information. The AuxPtr field represents an auxiliary advertising pointer. The SyncInfo field represents synchronization information. The TxPower field represents transmit power. The ACAD field represents Additional Controller Advertising Data.

The SYNC_CIS_SEARCH PDU and the SYNC_CIS_RSP PDU carry ABIS Info through ACAD.

Specifically, the difference between the SYNC_CIS_SEARCH PDU and the AUX_SYNC_IND PDU is that bit0 of the Extended Header Flags of the SYNC_CIS_SEARCH PDU is set to 1, indicating that its extended header contains the AdvA field. The AdvA field is the device address of the ABIS master device. The other field values of the SYNC_CIS_SEARCH PDU are the same as those of the AUX_SYNC_IND PDU, and the ABIS Info with the same content as BIGInfo is contained in the ACAD field. The AdvMode is set to Ob01, indicating a connectable undirected type. The SYNC_CIS_SEARCH PDU is not only used to provide the ABIS Info to the ABIS slave device, but also used by the ABIS master device to search for the ABIS slave devices around that need to establish a CIS link (that is, the second communication link) to transmit the audio data.

The difference between the SYNC_CIS_REQ PDU and the AUX_SYNC_IND PDU is that bit0 and bit1 of the Extended Header Flags of the SYNC_CIS_REQ PDU are both set to 1, indicating that its extended header contains two fields, the AdvA field and the TargetA field. The AdvA field is the device address of the ABIS slave device, and the TargetA field is the device address of the ABIS master device. However, the ACAD field of the SYNC_CIS_REQ PDU does not contain the ABIS Info, and the other field values are the same as those of the AUX_SYNC_IND PDU. The AdvMode is set to Ob11, indicating a connection request type. The content carried in the AdvData of the SYNC_CIS_REQ PDU comprises at least one part payload content that is exactly the same as the Link Layer Connection Isochronous Stream Request (LL_CIS_REQ) PDU in the BLE Audio protocol. The AdvData is used to establish the CIS link, and comprises an opcode and a control data (CtrData). The AdvData of the SYNC_CIS_REQ PDU may also carry information such as device name or Universally Unique Identifier (UUID). The SYNC_CIS_REQ PDU is used by the ABIS slave device to request to establish the CIS link with the ABIS master device and provide link negotiation parameters.

The difference between the SYNC_CIS_RSP PDU and the AUX_SYNC_IND PDU is that bit0 and bit1 of the Extended Header Flags of the SYNC_CIS_RSP PDU are both set to 1, indicating that its extended header contains two fields, the AdvA field and the TargetA field. The AdvA field is the device address of the ABIS master device, and the TargetA field is the device address of the ABIS slave device. The other field values of the SYNC_CIS_RSP PDU are the same as those of the AUX_SYNC_IND PDU, and the ABIS Info with the same content as BIGInfo is contained in the ACAD field. The AdvMode is set to Ob10, indicating a connection response type. The content carried in the AdvData of the SYNC_CIS_RSP at least comprises one part payload content that is exactly the same as the Link Layer Connection Isochronous Stream Response (LL_CIS_RSP) PDU in the BLE Audio protocol. The AdvData is used to respond to the request of the ABIS slave device to establish the CIS link, and includes an opcode and a control data (CtrData). LL_CIS_RSP is used by the ABIS master device to respond to the request of the ABIS slave device to establish the CIS link (that is, the second communication link) with the ABIS slave device.

The difference between the SYNC_CIS_IND PDU and the AUX_SYNC_IND PDU is that bit0 and bit1 of the Extended Header Flags of the SYNC_CIS_IND PDU are both set to 1, indicating that its extended header contains two fields, the AdvA field and the TargetA field. The AdvA field is the device address of the ABIS slave device, and the TargetA field is the device address of the ABIS master device. However, the ACAD field of the SYNC_CIS_IND PDU does not contain the ABIS Info, and the other field values are the same as those of the AUX_SYNC_IND PDU. The AdvMode is set to Ob11, indicating a connection indication type. The content carried in the AdvData of the SYNC_CIS_IND PDU comprises at least one part payload content that is exactly the same as the Link Layer Connection Isochronous Stream Indication (LL_CIS_IND) PDU in the BLE Audio protocol. The AdvData is used to establish the CIS link (that is, the second communication link), and includes an opcode and a control data (CtrData). The SYNC_CIS_IND PDU is used by the ABIS slave device to determine the link parameters for establishing the CIS link with the ABIS master device.

In one embodiment, the master device determines whether to receive the second audio packet at least before the starting time point of overlap in the time domain of the third time slot and the second time slot.

In a specific embodiment, if the current second time slot is at least partially overlapped with one current third time slot, and the master device needs to receive the second audio packet transmitted by the slave device within the current second isochronous interval in which the current third time slot is located, the master device receives the second audio packet transmitted by the slave device within the current second time slot based on the second communication link.

It can be understood that if the master device determines that the master device does not need to receive the second audio packet, the master device does not need to switch to the second communication link within the current second time slot.

Further, in one embodiment, an overlapping part in the second time slot may also be time-division multiplexed. That is, in the case where it is determined that the second audio packet does not need to be received, it is determined periodic advertising communication needs to be carried out within the current second time slot according to the predetermined periodic advertising interval whether, and/or it is determined whether control information needs to be sent within the current second time slot according to a predetermined rule.

It can be understood that the situation where the master device needs to receive the second audio packet transmitted by the slave device comprises: a situation where the master device needs to receive the second audio packet transmitted by the slave device for the first time, and a situation where the master device needs to receive the retransmitted second audio packet by the slave device.

For example, if the overlapping part of the current second time slot and the current third time slot is the earliest second sub-event interval of the current second isochronous interval, it is determined that the master device needs to receive the second audio packet transmitted by the slave device for the first time within this earliest first second sub-event interval. If the overlapping part is not the earliest second sub-event interval of the current isochronous interval, and the master device has not correctly received the second audio packet transmitted by the slave device for the first time before, it may be determined that the retransmitted second audio packet from the slave device needs to be received currently. If the master device has correctly received the second audio packet transmitted by the slave device for the first time, it may be determined that the second audio packet does not need to be received currently.

When the master device determines that the current second time slot does not need to receive the second audio packet, it may further determine whether there are other communication events that need to be executed in the current second time slot. The communication events comprise periodic advertising communication, system control, and the like.

For example, the master device may determine whether the periodic advertising communication needs to be performed within the current second time slot according to the bidirectional periodic advertising interval.

For another example, the second time slot may also comprise a control time slot. The master device determines to transmit the control information within the control time slot of the current second time slot according to a predetermined rule. The control information may be various control instructions required for system operation, such as volume adjustment, on/off information, and the like.

It can be understood that the timing for transmitting the control information may be preconfigured according to system operation needs.

In one embodiment, the second audio packet comprises a second parameter, and the second parameter is used to indicate whether the slave device has successfully received the first audio packet transmitted by the master device.

The method also comprises: the master device determines a transmission success probability of the first audio packet according to multiple second parameters; the master device updates a retransmission times of the first audio packet according to the transmission success probability of the first audio packet.

In this embodiment, by transmitting the second parameter through the second audio packet to indicate whether the slave device has successfully received the first audio packet transmitted by the master device, the transmission time slot of a separate acknowledgment packet may be avoided, and time slot resources may be further saved.

In addition, although the master device's retransmission of the first audio packet does not depend on the acknowledgment immediately fed back by the slave device, the acknowledgment delayedly fed back by the slave device through the second audio packet enables the master device to statistically determine the transmission success probability of the first audio packet based on the second parameter, and then update the retransmission times of the first audio packet accordingly. When the transmission success probability of the first audio packet is low, by increasing the retransmission times of the first audio packet, the transmission reliability of the first audio packet is guaranteed. When the transmission success probability of the first audio packet is high, by reducing the retransmission times of the first audio packet, the time length corresponding to the second time slot is extended, thereby improving the utilization rate of time slot resources.

For example, the ABIS slave device may be set to use the ABIS slave device (ABISS) PDU (that is, the second audio packet) to transmit the audio data and the second parameter. The ABISS PDU has the same structure as the BLE Connected Isochronous Stream (CIS) PDU but different header formats.

As shown in FIG. 8, on the basis of the header of the CIS PDU, the header format of the ABISS PDU sets a 1-bit Reserved for Future Use (RFU) as an ABISS field to indicate whether to enable the ABISS PDU.

When the ABISS field is assigned a value of 0, it indicates that the ABISS PDU is disabled. When the ABISS field is assigned a value of 1, it indicates that the ABISS PDU is enabled.

The meanings of other fields of the header of the ABISS PDU are the same as those of the header of the CIS PDU. LLID (Logical Link Identifier) is a logical link identifier and is used to indicate a payload type of the ABISS PDU. NESN (Next Expected Sequence Number) is a sequence number of the next expected ABISM PDU. SN (Sequence Number) is the current sequence number of the ABISS PDU. CIE (Close Isochronous Event) is a close isochronous event and indicates whether to end the isochronous event.

NPI (Null PDU Indicator) is a Null PDU identifier. In the ABISS PDU, NPI indicates whether the PDU is an ABISS Data PDU or an ABISS Null PDU. Length represents a payload length of the ABISS PDU. Additionally, there is also 1-bit RFU (Reserved for Future Use).

The NESN field may be understood as the aforementioned second parameter. For example, the value of the NESN field may be set to 0 or 1. When in two consecutive ABISS PDUs, the value of the NESN field changes from 1 to 0 or from 0 to 1, it means that the ABIS slave device has correctly received the first audio packet transmitted by the ABIS master device. When in two consecutive ABISS PDUs, the value of the NESN is either 1 or 0, it means that the ABIS slave device has not correctly received the first audio packet transmitted by the ABIS master device.

In one embodiment, when the transmission success probability of the first audio packet is low, the transmission success probability of the first audio packet may also be increased by increasing the transmission power of the channel where the first audio packet is located, adjusting the channel where the first audio packet is located, adjusting the coding rate, and other methods.

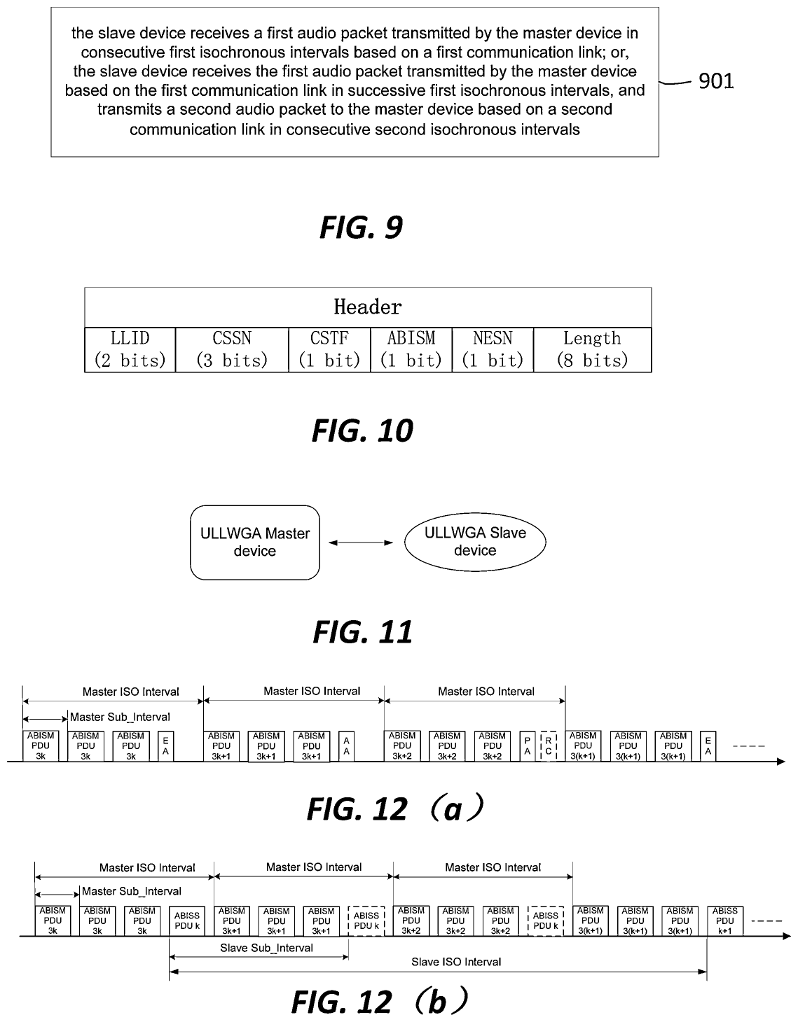

As shown in FIG. 9, a wireless audio data transmission method applied to a slave device is provided according to one embodiment of the present invention. The wireless audio data transmission method comprises: the slave device receives a first audio packet transmitted by the master device in consecutive first isochronous intervals based on a first communication link; or, the slave device receives the first audio packet transmitted by the master device based on the first communication link in successive first isochronous intervals, and transmits a second audio packet to the master device based on a second communication link in consecutive second isochronous intervals at 901.

A time length of the first isochronous interval is less than the time length of the second isochronous interval. The first isochronous interval comprises a first time slot and a second time slot. The second isochronous interval comprises a third time slot. The first time slot is a time slot for the master device to transmit the first audio packet. The second time slot is a time slot other than the first time slot within the first isochronous interval. The third time slot is a time slot for the slave device to transmit the second audio packet. A time domain position of the third time slot in one of the second isochronous intervals at least partially overlaps with the time domain position of one second time slot in the consecutive first isochronous intervals.

In one embodiment, based on the periodic advertising channel, bidirectional communication with the master device is performed to negotiate and establish the second communication link. The specific process is as described above and will not be repeated here.

In one embodiment, the second isochronous interval comprises P second sub-event intervals, and one second sub-event interval comprises one third time slot. P is a positive integer.

The slave device determines whether the second audio packet needs to be transmitted in the current second sub-event interval at least before the starting time point of the third time slot in each second sub-event interval. When it is needed to be sent, the second audio packet is transmitted within the third time slot of the current second sub-event interval.

In this embodiment, the slave device has an independent isochronous interval. The time slot and the starting time point for the slave device to transmit the second audio packet are also independently and fixedly configured. This avoids the problem that the slave device must determine the transmitting time of the slave device according to the transmitting end time of the master device in the CIG bidirectional link. This can improve the communication performance in the direction of the slave device.

The situation where the slave device determines that it needs to transmit the second audio packet comprises: a situation where the slave device transmits the second audio packet for the first time, and a situation where the slave device retransmits the second audio packet based on the preset retransmission times.

In one embodiment, the slave device transmits the second audio packet at most NSE_S times within the P second sub-event intervals. NSE_S is less than or equal to P.

In one embodiment, the first audio packet comprises a first parameter, and the first parameter is used to indicate whether the master device has successfully received the second audio packet transmitted by the slave device.

The slave device determines whether the second audio packet needs to be transmitted in the current second sub-event interval before the starting time point of each second sub-event interval. When the second audio packet is needed to be transmitted, the second audio packet is transmitted within the current second sub-event interval. Specifically, it includes following two situations.

In the case where the current second sub-event interval is the earliest second sub-event interval within the current second isochronous interval, it is determined that the second audio packet needs to be transmitted in the current second sub-event interval, and the second audio packet is transmitted within the current second sub-event interval.

In the case where the current second sub-event interval is not the earliest second sub-event interval within the current second isochronous interval, and the first parameter indicates that the master device has failed to successfully receive the second audio packet transmitted by the slave device, the second audio packet that has not been successfully received by the master device is retransmitted within the current second sub-event interval.

It can be understood that the transmitting or retransmitting of the second audio packet within the current second sub-event interval is performed within the third time slot of the current second sub-event interval.

In this embodiment, the first parameter carried in the first audio data packet is used to indicate whether the master device has successfully received the second audio data packet transmitted by the slave device. This method achieves feedback of acknowledgment for the corresponding second audio data packet without occupying a separate time slot for transmitting an acknowledgment packet, thereby further conserving time slot resources.

In one embodiment, it is also possible to configure the master device to continuously transmit the first audio data packet multiple times at a plurality of adjacent time domain positions in sequence, so as to increase the transmitting opportunities of the acknowledgment and make the transmission of the acknowledgment used to indicate whether the master device has successfully received the second audio data packet more reliable.

For example, the ABIS master device uses the ABIS master device (ABISM) PDU (that is, the first audio packet) to transmit the audio data and the first parameter.

As shown in FIG. 10, on the basis of the header of the BIS PDU, the header format of the ABISM PDU sets a 1-bit reserved field as an ABISM field, which is used to indicate whether the ABISM PDU is enabled.

When the ABISM field is assigned a value of 0, it indicates that the ABISM PDU is disabled. When the ABISM field is assigned a value of 1, it indicates that the ABISM PDU is enabled.

When the ABISM PDU is enabled, another 1-bit reserved field (RFU) is set as the next expected sequence number (NESN) for replying the acknowledgment to the ABIS slave device. If the NESN (i.e., the first parameter) in the header of the ABISM PDU remains unchanged, it means that the ABISS PDU transmitted by the ABIS slave device has not been correctly received. If the NESN in the ABISM PDU header changes, for example, from 1 to 0 or from 0 to 1, it means that the ABISS PDU (i.e., the second audio data packet) transmitted by the ABIS slave device has been correctly received.

The functions and usage methods of other fields in the header of the ABISM PDU are the same as those of the BIS PDU. The other fields in the header of the ABISM PDU include a Logical Link Identifier (LLID) used to indicate a payload type of the ABISM PDU, a Control Subevent Sequence Number (CSSN), a Control Subevent Transmission Flag (CSTF), and a Length for indicating a length of a payload of the ABISM PDU.

In one embodiment, the method further comprises: the slave device determines whether the second audio packet needs to be transmitted in the current second sub-event interval; the slave device determines whether the periodic advertising communication needs to be performed within the current second sub-event interval according to a predetermined periodic advertising interval, and/or determines whether control information transmitted by the master device needs to be received within the current second sub-event interval according to a predetermined rule when the second audio packet is not needed to be transmitted before the starting time point of each second sub-event interval.

In the case where the current second sub-event interval is not the earliest first second sub-event interval within the current second isochronous interval and the first parameter indicates that the master device has successfully received the second audio packet transmitted by the slave device, the slave device may determine that the second audio packet does not need to be transmitted by the slave device.

As mentioned before, the second time slot can be time-division multiplexed to execute different communication events. Therefore, when the slave device does not need to occupy the second time slot to transmit the second audio data packet, it can execute different communication events within the time domain range of the second time slot. The communication events include but are not limited to performing the periodic advertising communication with the master device or receiving control information from the master device. For example, in the case where the second communication link is disconnected, the slave device can request and restore the second communication link again within the bidirectional periodic advertising time slot of the second time slot. For another example, the master device can also communicate with a new slave device through bidirectional periodic advertising, thereby disconnecting the second communication link with the current slave device and allowing the new slave device to establish a new second communication link.

In one embodiment, the method further comprises: the slave device receives the first audio packet transmitted by the master device within the first time slot according to the starting time point of the first time slot after completing the transmitting of the second audio packet or the periodic advertising communication or receiving control information within one second sub-event interval.

For ease of understanding, the following describes a specific embodiment of the present invention in combination with a typical application scenario.

The present invention also provides an Ultra-Low Latency Wireless Gaming Audio (ULLWGA) system. As shown in FIG. 11, the ULLWGA system comprises one ULLWGA master device and one ULLWGA slave device.

The ULLWGA master device is set as a smart phone and the ULLWGA slave device is set as a wireless gaming headset. The delay required for the ULLWGA master device to transmit stereo game audio to the ULLWGA slave device is extremely low, and the delay required for a microphone of the ULLWGA slave device to transmit mono voice to the ULLWGA master device is relatively long.

The ULLWGA master device and the ULLWGA slave device transmit audio data to each other through the ABIS link. The ULLWGA master device is the ABIS master device and the ULLWGA slave device is the ABIS slave device. The ABIS link comprises the first communication link similar to the BIS link for point-to-multipoint communication and the second communication link similar to the CIS link for point-to-point communication.

The isochronous interval (Master ISO Interval, that is, the first isochronous interval) in the transmission direction of the master device of the ABIS link is 2.5 ms, and the sub-event interval (Master Sub_Interval, that is, the first sub-event interval) in the transmission direction of the master device is 625 μs. The number of sub-events NSE_M (Number of Sub-Event, NSE) within the isochronous interval of the master device is equal to 3, and an over-the-air packet length of the ABISM PDU is 420 μs.

The isochronous interval (Slave ISO Interval, that is, the second isochronous interval) in the transmission direction of the slave device of the ABIS link is 7.5 ms, and the sub-event interval (Slave Sub_Interval, that is, the second sub-event interval) in the transmission direction of the slave device is 2.5 ms. The number of sub-events NSE_S within the isochronous interval of the slave device is equal to 3, and an over-the-air packet length of the ABISS PDU is 420 μs.

Regardless of whether it is in the transmission direction of the master device or the slave device, a sampling rate of the digital audio signal is 48 KHz, the number of quantization bits for each sampling point is 16, and the digital audio signal of each audio channel is encoded using LC3 Plus (Low Complexity Communication Codec Plus).

For the transmission direction of the master device, the frame length of encoding is 2.5 ms, an encoding rate of a single channel is 144 kbps, and an encoding rate of two channels (stereo) is 288 kbps. For the transmission direction of the slave device, the frame length of encoding is 7.5 ms, and the encoding rate of a single channel is 96 kbps.

The size of a stereo Service Data Unit (SDU) in the transmission direction of the master device is 90 bytes, and the size of a mono Service Data Unit (SDU) in the transmission direction of the slave device is also 90 bytes. The BLE 2 Mbps physical layer (PHY) is used for transmission. The Over-the-air packet lengths of the ABISM PDU and the ABISS PDU are both 420 μs, and the intervals between two ABISM PDUs and between the ABISM PDU and the ABISS PDU are 205 μs.

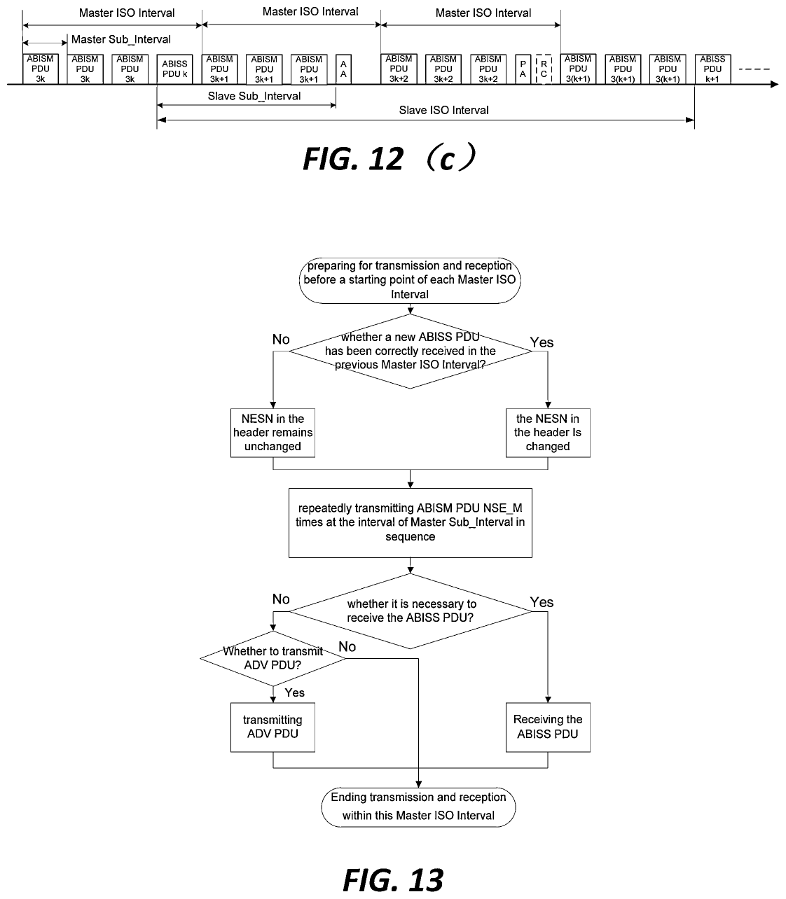

The time slot structure of the ABIS link in the ULLWGA system may be as shown in FIG. 12(a), FIG. 12(b), and FIG. 12(c).

FIG. 12(a) shows a time slot structure only in the transmission direction of the master device of the ABIS link (i.e., the situation where only the first communication link exists). In this case, only the AIBS master device transmits various advertising (ADV) PDUs (including ADV_EXT_IND PDU, AUX_ADV_IND PDU, and SYNC_CIS_SEARCH PDU) and ABISM PDU. “EA” represents the ADV_EXT_IND PDU transmitted by the AIBS master device on the primary advertising channel, “AA” represents the AUX_ADV_IND PDU transmitted by the AIBS master device on the secondary advertising channel, and “PA” represents the SYNC_CIS_SEARCH PDU transmitted by the AIBS master device on the periodic advertising channel.

In addition, if the ABIS master device and the ABIS slave device establish a CIS link as the second communication link through the BPA link, then “PA” in the figure can also represent the SYNC_CIS_RSP PDU that may be transmitted by the ABIS master device on the periodic advertising channel, and a dashed box “RC” can represent the SYNC_CIS_REQ PDU and SYNC_CIS_IND PDU that may be transmitted by the AIBS slave device on the periodic advertising channel. There is an interval of T_IFS between “PA” and “RC”.

FIG. 12(b) shows a time slot structure for bidirectional communication between the ABIS master device and the ABIS slave device. In this structure, the time slot for the ABIS slave device to transmit the ABISS PDU is time-division shared with the time slot for various ADV PDUs and the time slot for transmitting various PDUs on the BPA link to shown in FIG. 12(a). However, the retransmission time slot (indicated by the dashed box of the ABISS PDU) of the ABIS slave device occupies the time slot of various ADV PDUs of the ABIS master device and the time slot of various PDUs of the BPA link. Therefore, only the ABIS master device transmitting the ABISM PDU and the ABIS slave device transmitting the ABISS PDU are shown.

FIG. 12(c)) shows another time slot structure for bidirectional communication between the ABIS master device and the ABIS slave device. In this structure, the time slot for the ABIS slave device to transmit the ABISS PDU is time-division shared with the time slot for various ADV PDUs and the time slot for transmitting various PDUs on the BPA link shown in FIG. 12(a), and the shared time slots are preferentially used for the ABIS slave device to transmit the ABISS PDU. Therefore, in FIG. 12(c), only when the ABIS slave device does not need to retransmit the ABISS PDU in the shared part of the time slots, the shared part of the time slots can be used for the time slot for various ADV PDUs of the master device and the time slots for various PDUs of the BPA link. As shown in the figure, “EA” represents the ADV_EXT_IND PDU transmitted by the ABIS master device on the primary advertising channel, “AA” represents the AUX_ADV_IND PDU transmitted by the ABIS master device on the secondary advertising channel, and “PA” and “RC” represent the various PDUs that may be transmitted and received by the ABIS master and slave devices on the BPA link.

In one specific embodiment, since the CIS link has already been established in FIG. 12(c), the ABIS master device may also not allow other ABIS slave devices to establish the CIS link. That is to say, the ABIS master device will not transmit the SYNC_CIS_RSP PDU to other ABIS slave devices, and other ABIS slave devices will have no opportunity to transmit the SYNC_CIS_IND PDU either.

In the time slot structure shown in FIG. 12, one Slave ISO Interval (the isochronous interval of the slave device, which can be understood as the second isochronous interval) is three times as long as one Master ISO Interval (the isochronous interval of the master device, which can be understood as the first isochronous interval). One Master ISO Interval is equal in length to and overlaps with one Slave Sub_Interval (the sub-event interval of the slave device, which can be understood as the second sub-event interval). The overlapping part is equal to the Master Sub_Interval (the sub-event interval of the master device, which can be understood as the first sub-event interval).

In one Master ISO Interval, three Master Sub_Intervals are comprised in sequence for transmitting the ABISM PDU, and another Master Sub_interval overlaps with one Slave Sub_Interval, so that the ABIS master device may time-division multiplex to receive the ABISS PDU transmitted or retransmitted by the ABIS slave device within the Slave Sub_Interval of the Slave ISO Interval, or transmit the ADV PDU or transmit and receive the PDUs of the BPA link within the another Master Sub_Interval.

Similarly, in one Slave Sub_Interval, the ABIS slave device transmits or retransmits the ABISS PDU in the part (that is, the third time slot) overlapping with the Master Sub interval, or receives the ADV PDU transmitted by the ABIS master device or transmits and receives the PDUs of the BPA link. The time length of the remaining time slot of the Slave Sub_Interval may be equivalent to that of three consecutive Master Sub_Intervals, so that after the ABIS slave device completes the communication event in the current Slave Sub_Interval, the ABIS slave device switches to the first isochronous interval and receives the ABISM PDU transmitted by the ABIS master device based on the Master Sub_Interval of the first isochronous interval.

In the time slot structure as shown in FIG. 12, if the ABIS master device has established the CIS link with the ABIS slave device and does not allow other ABIS slave devices to access or receive the ABISM PDU transmitted by the ABIS master device, the ABIS master device may stop transmitting the ADV PDUs.

If the ABIS slave device that has established the CIS link is disconnected, or if the ABIS master device cannot correctly receive the ABISS PDU transmitted by the ABIS slave device for a certain period of time, the ABIS master device may retransmit the ADV PDU to facilitate the disconnected ABIS slave device or other ABIS slave devices to synchronize or establish a new CIS link.

In addition, even if the ABIS master device has established the CIS link with the ABIS slave device, the ABIS master device may also transmit the ADV PDUs to allow other ABIS slave devices to synchronize and receive the ABISM PDU transmitted by the ABIS master device. However, establishing the CIS link is prohibited.

According to the time slot structure and the time slot parameters shown in FIG. 12, it is possible to achieve an end to end game audio latency of no more than 10 ms and an end to end wireless microphone audio latency of no more than 25 ms.

For example, transmission and reception processes of the ABIS master device may be as follows.

As shown in FIG. 13, the ABIS master device first prepares for transmission and reception before a starting point of each Master ISO Interval, and then determines whether a new ABISS PDU transmitted by the ABIS slave device has been correctly received within the last Master Sub_Interval in the previous Master ISO Interval.

If the new ABISS PDU is not correctly received, the NESN in the header of the ABISM PDU to be transmitted in this Master ISO Interval remains unchanged. If the new ABISS PDU is correctly received, the value of the NESN in the header of the ABISM PDU to be transmitted in this Master ISO Interval is changed, such as changing from 1 to 0 or from 0 to 1. The change of the NESN is used to transmit the acknowledgment for receiving the ABISS PDU to the ABIS slave device.

Then, the ABIS master device repeatedly transmits the ABISM PDU NSE_M times at the interval of Master Sub_Interval in sequence. After transmitting the ABISM PDU, the ABIS master device determines whether it is necessary to receive the ABISS PDU transmitted by the ABIS slave device. If it is necessary to receive the ABISS PDU transmitted by the ABIS slave device, the transmission and reception within this Master ISO Interval is ended after the ABIS master device receives the ABISS PDU.

If it is not necessary to receive the ABISS PDU transmitted by the ABIS slave device and there is no need to transmit any ADV PDUs, the transmission and reception within this Master ISO Interval is ended.

If it is not necessary to receive the ABISS PDU transmitted by the ABIS slave device, but it is necessary to transmit ADV PDUs, after the ABIS master device transmits the ADV PDUs, the transmission and reception within this Master ISO Interval is ended.

The situation where it is not necessary to receive the ABISS PDU transmitted by the ABIS slave device is that if the ABISS PDU transmitted by the ABIS slave device in the first Slave Sub_Interval in the Slave ISO Interval has been correctly received by the ABIS master device, then it is not necessary to receive the ABISS PDU again in other Slave Sub_Intervals of the Slave ISO Interval.

The transmission and reception process of the ABIS slave device may be as follows.

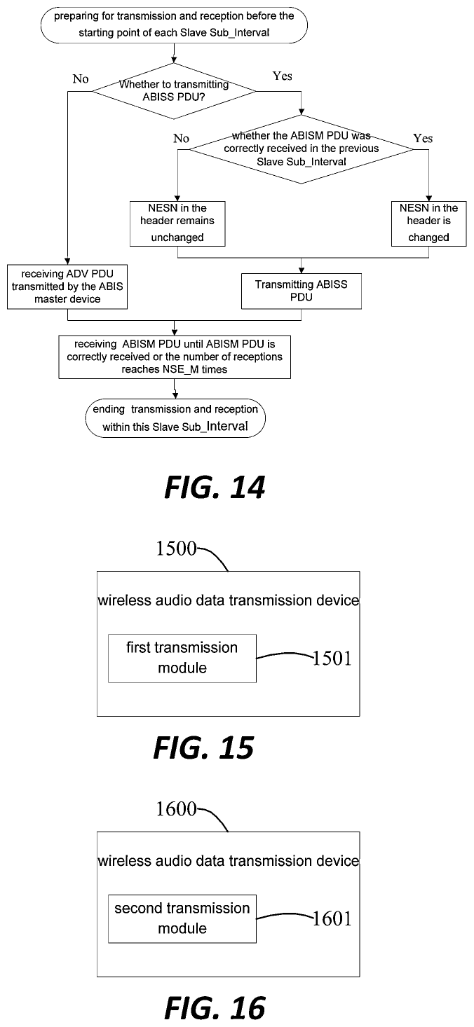

As shown in FIG. 14, the ABIS slave device prepares for transmission and reception, and determines whether it is necessary to transmit the ABISS PDU before the starting point of each Slave Sub_Interval.

If it is in the first Slave Sub_Interval of the Slave ISO Interval, the ABISS PDU needs to be transmitted.

If it is in other Slave Sub_Intervals, it is necessary to determine whether to retransmit the ABISS PDU according to the acknowledgment of the ABISS PDU according to the header of the ABISM PDU received in the previous Slave Sub_Interval. That is, a change in the NESN carried in the header of the ABISM PDU means that retransmission is not required. If the NESE does not change, the retransmission is required.

If the ABIS slave device does not need to transmit the ABISS PDU in the current Slave Sub_Interval, the ABIS slave device will receive the ADV PDU that may be transmitted by the ABIS master device.

If the ABIS slave device needs to transmit the ABISS PDU in the current Slave Sub_Interval, the value of the NESN in the header of the ABISS PDU to be transmitted is set based on whether the ABISM PDU was correctly received in the previous Slave Sub_Interval. If the ABISM PDU is correctly received, the value of the NESN of the header of the ABISS PDU is changed. If the ABISM PDU is not correctly received, the value of the NESN in the header of the ABISS PDU remains unchanged. After setting the NESE of the header, the ABISS PDU is transmitted.

The ABIS slave device either receives the ADV PDU sent by the ABIS master device or sends the ABISS PDU first, and then receives the ABISM PDU sent by the ABIS master device until the ABISM PDU is correctly received or the number of receptions reaches NSE_M times to end the transmission and reception within this Slave Sub_Interval.

FIG. 15 is a wireless audio data transmission device 1500 applied to a master device provided according to one embodiment of the present invention. Referring to FIG. 15, the device 1500 comprises: a first transmission module 1501 is configured for transmitting a first audio packet to a slave device in consecutive first isochronous intervals based on a first communication link by the master device, and/or, receiving a second audio packet transmitted from the slave device in consecutive second isochronous intervals based on a second communication link.

A time length of the first isochronous interval is less than the time length of the second isochronous interval. The first isochronous interval comprises a first time slot and a second time slot. The second isochronous interval comprises a third time slot. The first time slot is a time slot for the master device to transmit the first audio packet. The second time slot is a time slot other than the first time slot within the first isochronous interval. The third time slot is a time slot for the slave device to transmit the second audio packet. A time domain position of the third time slot in one of the second isochronous intervals at least partially overlaps with the time domain position of one second time slot in the consecutive first isochronous intervals.

The wireless audio data transmission device 1500 provided according to one embodiment of the present invention can implement each process of the wireless audio data transmission method on the master device side above mentioned. To avoid repetition, details are will not be repeated here.

FIG. 16 is a wireless audio data transmission device 1600 applied to a slave device provided according to one embodiment of the present invention. Referring to FIG. 16, the device 1600 comprises a second transmission module 1601.

The second transmission module 1601 is configured for: receiving a first audio packet transmitted by the master device in consecutive first isochronous intervals based on a first communication link; or receiving the first audio packet transmitted by the master device based on the first communication link in successive first isochronous intervals, and transmitting a second audio packet to the master device based on a second communication link in consecutive second isochronous intervals.

A time length of the first isochronous interval is less than the time length of the second isochronous interval. The first isochronous interval comprises a first time slot and a second time slot. The second isochronous interval comprises a third time slot. The first time slot is a time slot for the master device to transmit the first audio packet. The second time slot is a time slot other than the first time slot within the first isochronous interval. The third time slot is a time slot for the slave device to transmit the second audio packet. A time domain position of the third time slot in one of the second isochronous intervals at least partially overlaps with the time domain position of one second time slot in the consecutive first isochronous intervals.

The wireless audio data transmission device 1600 can implement each process of the wireless audio data transmission method on the slave device side above mentioned. To avoid repetition, it will not be repeated here.

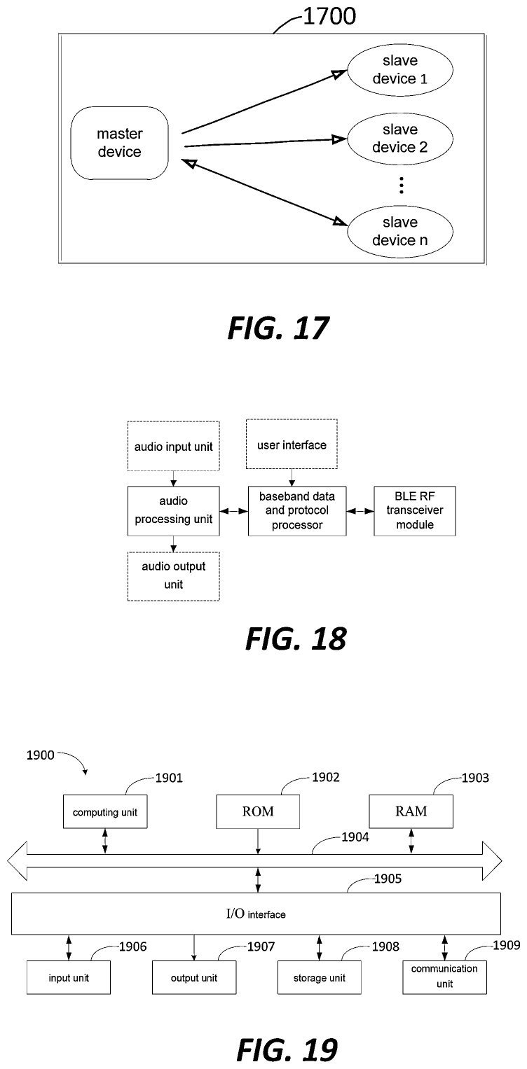

As shown in FIG. 17, a wireless audio data transmission system 1700 is provided according to one embodiment of the present invention.

The system 1700 comprises: One master device and n slave devices, n is a positive integer.

The master device transmits a first audio packet to the n slave devices within consecutive first isochronous intervals based on a first communication link, and/or the master device receives a second audio packet transmitted by a target slave device within consecutive second isochronous intervals based on a second communication link. The target slave device is one of the n slave devices.

A time length of the first isochronous interval is less than the time length of the second isochronous interval. The first isochronous interval comprises a first time slot and a second time slot. The second isochronous interval comprises a third time slot. The first time slot is a time slot for the master device to transmit the first audio packet. The second time slot is a time slot other than the first time slot within the first isochronous interval. The third time slot is a time slot for the slave device to transmit the second audio packet. A time domain position of the third time slot in one of the second isochronous intervals at least partially overlaps with the time domain position of one second time slot in the consecutive first isochronous intervals.

The wireless audio data transmission system provided according to one embodiments of the present invention can implement each process of the wireless audio data transmission method on the master device side and each process of the wireless audio data transmission method on the slave device side. To avoid repetition, it will not be repeated here.

When a structure shown in FIG. 18 is for the ULLWGA master device, the ULLWGA master device may comprise a user interface, an audio input unit, an audio output unit, an audio processing unit, a baseband data and protocol processor, and a BLE radio frequency transceiver module.

The audio input unit acquires a digital audio signal and transmits it to the audio processing unit. The audio processing unit compresses and encodes the digital audio signal into audio data using LC3.

The baseband data and protocol processor executes the ABIS protocol and processes the audio data into an ABISM PDU suitable for transmission by the BLE radio frequency transceiver module.

The baseband data and protocol processor also executes the ABIS protocol, processes the ABISS PDU received by the BLE radio frequency (RF) transceiver module, and transmits it to the audio processing unit.

The audio processing unit is used for post-processing such as LC3 audio decoding, packet loss processing, equalization and sound effects. The audio output unit is used to convert the audio signal into sound signal.

The BLE radio frequency transceiver module is used for the transmission and reception of various PDUs related to the ABIS protocol and the BPA protocol.

The BLE radio frequency transceiver module may also comprise a high-speed physical layer supporting future BLE, such as 4 Mbps, 6 Mbps, and 8 Mbps.

The user interface may be a key, a touch panel, a wireless control interface, etc.

When the structure shown in FIG. 18 is for the ULLWGA slave device, the ULLWGA slave device may comprise a user interface, an audio input unit, an audio output unit, an audio processing unit, a baseband data and protocol processor, and a BLE radio frequency transceiver module.

The audio input unit acquires a digital audio signal and transmits it to the audio processing unit. The audio processing unit compresses and encodes the digital audio signal into audio data using LC3.

The baseband data and protocol processor executes the ABIS protocol and processes the audio data into an ABISS PDU suitable for transmission by the BLE radio frequency transceiver module.

The baseband data and protocol processor also executes the ABIS protocol, processes the ABISM PDU received by the BLE radio frequency transceiver module, and transmits it to the audio processing unit.

The audio processing unit is used for post-processing such as LC3 audio decoding, packet loss processing, equalization and sound effects.

The audio output unit is used to convert the audio signal into sound signal.

The BLE radio frequency transceiver module is used for the transmission and reception of various PDUs related to the ABIS protocol and the BPA protocol.

The BLE radio frequency transceiver module may also comprise a high-speed physical layer supporting future BLE, such as 4 Mbps, 6 Mbps, and 8 Mbps.

The user interface may be a key, a touch panel, a wireless control interface, etc.

According to one embodiment of the present invention, the present invention also provides an electronic device and a readable storage medium.

FIG. 19 shows a schematic block diagram of an exemplary electronic device 1900 that may be used to implement embodiments of the present invention. As shown in FIG. 19, the electronic device 1900 comprises a computing unit 1901, which may execute various appropriate actions and processes according to a computer program stored in a read-only memory (ROM) 1902 or a computer program loaded from a storage unit 1908 into a random access memory (RAM) 1903. In the RAM 1903, various programs and data required for the operation of the electronic device 2200 may also be stored. The computing unit 1901, the ROM 1902, and the RAM 1903 are connected to each other through a bus 1904. An input/output (I/O) interface 1905 is also connected to the bus 1904.

Multiple components in the electronic device 1900 are connected to an I/O interface 1905. The components includes: an input unit 1906, such as a keyboard, mouse, etc.; an output unit 1907, such as various types of displays, speakers, etc.; a storage unit 1908, such as a magnetic disk, optical disk, etc.; and a communication unit 1909, such as a network card, modem, wireless communication transceiver, etc. The communication unit 1909 allows the electronic device 1900 to exchange information/data with other devices through a computer network such as the Internet and/or various telecommunications networks.

The computing unit 1901 may be various general-purpose and/or special-purpose processing components with processing and computing capabilities. Some examples of computing unit 1901 comprise, but are not limited to, a central processing unit (CPU), a graphic processing unit (GPU), various special artificial intelligence (AI) computing chips, various computing units running machine learning model algorithms, a digital signal processor (DSP), and any appropriate processor, controller, microcontroller, etc. The computing unit 1901 executes the various methods and processes described above, such as the wireless audio data transmission method. For example, in some embodiments, the wireless audio data transmission method may be implemented as a computer software program that is tangibly contained in a machine-readable medium, such as storage unit 1908. In some embodiments, part or all of the computer program may be loaded and/or installed on the device 1900 via the ROM 1902 and/or the communication unit 1909. When the computer program is loaded into RAM 1903 and executed by the computing unit 1901, one or more operations of the wireless audio data transmission method described above may be executed. Alternatively, in other embodiments, the computing unit 1901 may be configured to execute the wireless audio data transmission method in any other appropriate way (for example, by means of firmware).

Program code for implementing the methods of the present invention may be written in any combination of one or more programming languages. Such program code may be provided to a processor or controller of a general-purpose computer, a specialized computer, or other programmable data processing device such that the program code when executed by the processor or controller causes the functions/operations set forth in the flowchart and/or the block diagram to be implemented. The program code may be executed entirely on the machine, partially on the machine, partially on the machine as a stand-alone software package and partially on a remote machine or entirely on a remote machine or server.

In one embodiment, the present invention also provides a computer-readable storage medium having a computer program stored thereon. When the computer program is executed by a processor to realize the BLE broadcast communication method in the above-described embodiments and can achieve the same technical effect, which will not be repeated herein in order to avoid repetition. The computer-readable storage medium can be a read-only memory (ROM), random access memory (RAM), magnetic disc or optical disc, etc.

The embodiments of this application are described above in conjunction with the accompanying drawings, but this application is not limited to the specific embodiments described above, the specific embodiments described above are merely illustrative and not limiting, and the person of ordinary skill in the field of this application, without departing from the purpose of the application and the scope of protection of the claims, may also make many forms, all of which are under the protection of this application.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A wireless audio data transmission method applied to a master device, comprising:
transmitting a first audio packet to a slave device in consecutive first isochronous intervals based on a first communication link by the master device; and/or,
receiving a second audio packet transmitted from the slave device in consecutive second isochronous intervals based on a second communication link by the master device, wherein a time length of each first isochronous interval is less than a time length of each second isochronous interval, each first isochronous interval comprises a first time slot for the master device to transmit the first audio packet and a second time slot being a time slot other than the first time slot within each first isochronous interval, and each second isochronous interval comprises at least one third time slot for the slave device to transmit the second audio packet, and
wherein a time domain position of the third time slot within one of the second isochronous intervals at least partially overlaps with a time domain position of one second time slot in the consecutive first isochronous intervals.

2. The method according to claim 1, wherein the first time slot comprises Q1 first sub-event intervals, the second time slot comprises Q2 first sub-event intervals, each second isochronous interval comprises P second sub-event intervals, and one second sub-event interval comprises one third time slot, wherein Q1, Q2, and P are positive integers.

3. The method according to claim 2, wherein
a starting time point of the earliest first sub-event interval of the Q2 first sub-event intervals of the second time slot is a first starting point,
a starting time point of the third time slot in the second sub-event interval is the same as the first starting point of one second time slot.

4. The method according to claim 2, wherein the time domain positions of the Q1 first sub-event intervals are sequentially adjacent within each first isochronous interval, and the master device transmits the first audio packet NSE_M times consecutively within the Q1 first sub-event intervals, NSE_M being less than or equal to Q1.

5. The method according to claim 1, wherein the master device transmits link information of the first communication link based on a periodic advertising channel in the second time slot for the slave device to synchronize with the master device and receive the first audio packet based on the first communication link;
the master device further communicates bi-directionally with the slave device within the second time slot based on the periodic advertising channel to negotiate and establish the second communication link.

6. The method according to claim 1, wherein the master device determines whether to receive the second audio packet at least before the starting time point of overlap in the time domain of the third time slot and the second time slot,
if the current second time slot is at least partially overlapped with one current third time slot, and the master device needs to receive the second audio packet transmitted by the slave device within the current second isochronous interval in which the current third time slot is located, the master device receives the second audio packet transmitted by the slave device within the current second time slot based on the second communication link;
if it is determined that the second audio packet does not need to be received, it is determined whether a periodic advertising communication needs to be performed in the current second time slot according to a predetermined periodic advertising interval, and/or it is determined whether a control information needs to be transmitted in the current second time slot according to a predetermined rule.

7. The method according to claim 1, wherein the time length of the second isochronous interval is i times the time length of the first isochronous interval, i being an integer greater than 1;
an encoded frame length of the first communication link is less than an encoded frame length of the second communication link.

8. The method according to claim 1, wherein the second audio packet comprises a second parameter, the second parameter is configured to indicate whether or not the slave device successfully receives the first audio packet transmitted by the master device,
the method further comprises:
determining, by the master device, a transmission success probability of the first audio packet based on a plurality of the second parameters; and
updating, by the master device, a retransmission times of the first audio packet according to the transmission success probability of the first audio packet.

9. A wireless audio data transmission method, applied to a slave device, comprising:
receiving a first audio packet transmitted by the master device in consecutive first isochronous intervals based on a first communication link by the slave device; or
receiving the first audio packet transmitted by the master device based on the first communication link in successive first isochronous intervals, and transmitting a second audio packet to the master device based on a second communication link in consecutive second isochronous intervals by the slave device;
wherein a time length of each first isochronous interval is less than a time length of each second isochronous interval, each first isochronous interval comprises a first time slot for the master device to transmit the first audio packet and a second time slot being a time slot other than the first time slot within each first isochronous interval, and each second isochronous interval comprises at least one third time slot for the slave device to transmit the second audio packet,
wherein a time domain position of the third time slot within one of the second isochronous intervals at least partially overlaps with a time domain position of one second time slot in the consecutive first isochronous intervals.

10. The method according to claim 9, wherein the second isochronous interval comprises P second sub-event intervals, one second sub-event interval comprises one third time slot, P being a positive integer,
the slave device determines whether the second audio packet needs to be transmitted in the current second sub-event interval at least before a starting time point of the third time slot in each second sub-event interval, and the slave device transmits the second audio packet within the third time slot of the current second sub-event interval when the second audio packet needs to be transmitted.

11. The method according to claim 10, wherein the slave device transmits the second audio packet at most NSE_S times within the P second sub-event intervals, wherein NSE_S is less than or equal to P.

12. The method according to claim 10, wherein the first audio packet comprises a first parameter being configured to indicate whether the master device successfully receives the second audio packet transmitted by the slave device;
in the case where the current second sub-event interval is the earliest second sub-event interval within the current second isochronous interval, it is determined that the second audio packet needs to be transmitted in the current second sub-event interval, and the second audio packet is transmitted within the current second sub-event interval;
in the case where the current second sub-event interval is not the earliest second sub-event interval within the current second isochronous interval, and the first parameter indicates that the master device has failed to successfully receive the second audio packet transmitted by the slave device, the second audio packet that has not been successfully received by the master device is retransmitted within the current second sub-event interval.

13. The method according to claim 12, further comprising:
determining, by the slave device, whether the second audio packet needs to be transmitted within the current second sub-event interval before the starting time point of each second sub-event interval;
determining whether a periodic advertising communication needs to be performed within the current second sub-event interval according to a predetermined periodic advertising interval, and/or determine whether a control information transmitted by the master device needs to be received within the current second sub-event interval according to the predetermined rule when the second audio packet does not need to be transmitted within the current second sub-event interval.

14. The method according to claim 13, further comprising:
receiving the first audio packet transmitted by the master device within the first time slot according to a starting time point of the first time slot after completing transmitting of the second audio packet or the periodic advertising communication or receiving of the control information within one of the second sub-event intervals.

15. The method according to claim 9, further comprising:
receiving, based on a periodic advertising channel by the slave device, link information of the first communication link transmitted by the master device for synchronizing with the master device and receiving the first audio packet based on the first communication link; and
communicating bi-directionally with the master device to negotiate and establish the second communication link based on the periodic advertising channel.

16. A wireless audio data transmission device applied to a master device, comprising:
a first transmission module for transmitting a first audio packet to a slave device in consecutive first isochronous intervals based on a first communication link, and/or, receiving a second audio packet transmitted from the slave device in consecutive second isochronous intervals based on a second communication link;
wherein a time length of each first isochronous interval is less than a time length of each second isochronous interval, each first isochronous interval comprises a first time slot for the master device to transmit the first audio packet and a second time slot being a time slot other than the first time slot within each first isochronous interval, and each second isochronous interval comprises at least one third time slot for the slave device to transmit the second audio packet,
wherein a time domain position of the third time slot within one of the second isochronous intervals at least partially overlaps with a time domain position of one second time slot in the consecutive first isochronous intervals.

17. The device according to claim 16, wherein the first time slot comprises Q1 first sub-event intervals, the second time slot comprises Q2 first sub-event intervals, each second isochronous interval comprises P second sub-event intervals, and one second sub-event interval comprises one third time slot, wherein Q1, Q2, and P are positive integers,
a starting time point of the earliest first sub-event interval of the Q2 first sub-event intervals of the second time slot is a first starting point,
a starting time point of the third time slot in the second sub-event interval is the same as the first starting point of one second time slot.

18. The device according to claim 16, wherein
the first transmission module transmits link information of the first communication link based on a periodic advertising channel in the second time slot for the slave device to synchronize with the master device and receive the first audio packet based on the first communication link;
the first transmission module further communicates bi-directionally with the slave device within the second time slot based on the periodic advertising channel to negotiate and establish the second communication link.

19. The device according to claim 16, wherein
the first transmission module determines whether to receive the second audio packet at least before the starting time point of overlap in the time domain of the third time slot and the second time slot,
if the current second time slot is at least partially overlapped with one current third time slot, and the first transmission module needs to receive the second audio packet transmitted by the slave device within the current second isochronous interval in which the current third time slot is located, the first transmission module receives the second audio packet transmitted by the slave device within the current second time slot based on the second communication link;
if it is determined that the second audio packet does not need to be received, it is determined whether a periodic advertising communication needs to be performed in the current second time slot according to a predetermined periodic advertising interval, and/or it is determined whether a control information needs to be transmitted in the current second time slot according to a predetermined rule.

20. The device according to claim 16, wherein the second audio packet comprises a second parameter, the second parameter is configured to indicate whether or not the slave device successfully receives the first audio packet transmitted by the master device,
the first transmission module is further configured for:
determining a transmission success probability of the first audio packet based on a plurality of the second parameters; and
updating a retransmission time of the first audio packet according to the transmission success probability of the first audio packet
